(19) United States
(12) Patent Application Publication
(10) Pub. No.: US 2024/0057130 A1
(43) Pub. Date: Feb. 15, 2024

(54) SYSTEM AND METHOD OF MULTICAST RECEPTION AND SMALL DATA TRANSMISSION

(71) Applicant: Samsung Electronics Co., Ltd., Gyeonggi-do (KR)

(72) Inventors: Anil AGIWAL, Gyeonggi-do (KR); Sangkyu BAEK, Gyeonggi-do (KR)

(21) Appl. No.: 18/363,392

(22) Filed: Aug. 1, 2023

(30) Foreign Application Priority Data
Aug. 9, 2022 (KR) 10-2022-0099114

(51) Int. Cl. H04W 72/30; H04W 4/06

(52) U.S. Cl. CPC H04W 72/30; H04W 4/06; H04W 76/27

(57) ABSTRACT

The disclosure relates to a 5G or 6G communication system for supporting a higher data transmission rate. The present disclosure provides an apparatus, a method and a system for MBS multicast reception and small data transmission. A method performed by a terminal includes receiving, from a BS, an RRC release message including information indicating a suspend configuration for an RRC inactive state; identifying whether an SDT procedure is ongoing in the RRC inactive state, in case that there is a configuration by an upper layer for MBS multicast reception; and monitoring a paging channel for paging using a TMGI associated with an MBS session, based on the SDT procedure being not ongoing. The MBS session is associated with a bearer for the MBS multicast reception.

### CROSS-REFERENCE TO RELATED APPLICATIONS

This application is based on and claims priority under 35 U.S.C. § 119 to Korean Patent Application No. 10-2022-0099114, which was filed in Korean Intellectual Property Office on Aug. 9, 2022, the entire disclosure of which is incorporated herein by reference.

### BACKGROUND

### 1. Field

The disclosure relates generally to a wireless communication system, and more particularly, to an apparatus, method, and system for multicast and broadcast service (MBS) multicast reception and small data transmission (SDT).

### 2. Description of Related Art

5^{th} generation (5G) mobile communication technologies define broad frequency bands such that high transmission rates and new services are possible, which can be implemented in “sub 6 GHz” bands such as 3.5 GHz, and also in “above 6 GHz” bands, which may be referred to as mmWave, including 28 GHz and 39 GHz. In addition, there has been consideration for implementing 6^{th} generation (6G) mobile communication technologies (also referred to as beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by future 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN), which is UE-satellite direct communication for providing coverage in an area in which communication with terrestrial networks is unavailable, and positioning.

There has also been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure is made to address at least the above-mentioned problems and/or disadvantages and to provide at least the advantages described below.

An aspect of the disclosure is to provide a communication method and system for converging a 5G communication system for supporting higher data rates beyond a 4G communication system.

In accordance with an aspect of the disclosure, a method performed by a terminal is provided. The method includes receiving, from a base station (BS), a radio resource control (RRC) release message including information indicating a suspend configuration for an RRC inactive state; identifying whether an SDT procedure is ongoing in the RRC inactive state, in case that there is a configuration by an upper layer for an MBS multicast reception; and monitoring a paging channel for paging using a temporary mobile group identity (TMGI) associated with an MBS session, based on the SDT procedure being not ongoing, wherein the MBS session is associated with a bearer for the MBS multicast reception.

In accordance with another aspect of the disclosure, a terminal is provided. The terminal includes a transceiver; and a controller configured to control the transceiver to receive, from a BS, an RRC release message including information indicating a suspend configuration for an RRC inactive state, identify whether an SDT procedure is ongoing in the RRC inactive state, in case that there is a configuration by an upper layer for an MBS multicast reception, and monitor a paging channel for paging using a TMGI associated with an MBS session, based on the SDT procedure being not ongoing, wherein the MBS session is associated with a bearer for the MBS multicast reception.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flow chart illustrating a UE operation according to an embodiment;

FIG. 2 is a flow chart illustrating a UE operation according to an embodiment;

FIG. 3 is a flow chart illustrating a UE operation according to an embodiment;

FIG. 4 is a flow chart illustrating a UE operation according to an embodiment;

FIG. 5 illustrates a terminal according to an embodiment; and

FIG. 6 illustrates a BS according to an embodiment.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are used to provide a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

Singular forms such as “a,” “an,” and “the” include plural referents unless the context clearly dictates otherwise. Thus, for example, reference to “a component surface” includes reference to one or more of such surfaces.

The term “substantially” is meant to convey that the recited characteristic, parameter, or value need not be achieved exactly, but that deviations or variations, including, e.g., tolerances, measurement error, measurement accuracy limitations and other factors known to those of skill in the art, may occur in amounts that do not preclude the effect the characteristic was intended to provide.

Blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

The words “unit”, “module”, or the like may refer to a software component or hardware component, such as a field-programmable gate array (FPGA) or an application-specific integrated circuit (ASIC) capable of carrying out a function or an operation. However, a “unit”, or the like, is not limited to hardware or software. A unit, or the like, may be configured to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Herein, a BS is an entity communicating with a UE) and may be referred to as a base transceiver station (BTS), a node B (NB), an evolved NB (eNB), an access point (AP), a 5G NB (5GNB), or a next generation NB (gNB).

A UE is an entity communicating with a BS and may be referred to as a device, a mobile station (MS), a mobile equipment (ME), or a terminal.

As described above, several broadband wireless technologies have been developed to meet the growing number of broadband subscribers and to provide more and better applications and services. A 2nd generation (2G) wireless communication system was developed to provide voice services while ensuring the mobility of users. A 3rd generation (3G) wireless communication system supports voice service and data service. A 4G wireless communication system provides high-speed data services. However, a 4G wireless communication system has insufficient resources to meet the growing demand for high speed data services. Accordingly, a 5G wireless communication system (i.e., next generation radio or NR) is being developed to meet the growing demand for high speed data services and support ultra-reliability and low latency applications.

A 5G wireless communication system supports lower frequency bands as well as higher frequency (mmWave) bands, e.g., 10 GHz to 100 GHz bands, to provide higher data rates. To mitigate propagation loss of the radio waves and increase the transmission distance, the beamforming, massive MIMO, FD-MIMO, array antenna, an analog beam forming, and large scale antenna techniques are being considered in the design of 5G wireless communication system. In addition, a 5G wireless communication system is expected to address different use cases having quite different requirements in terms of data rate, latency, reliability, mobility, etc. However, it is expected that the design of the air-interface of a 5G wireless communication system will be flexible enough to serve UEs having different capabilities depending on the use case and market segments of the UEs will cater services to the end customers. A 5G wireless communication system wireless system is expected to address eMBB, mMTC, URLLC, etc.

The eMBB requirements, like tens of Gbps data rate, low latency, high mobility, etc., address the market segment representing the conventional wireless broadband subscribers providing Internet connectivity everywhere, all the time, and on the go.

The mMTC requirements, like high connection density, infrequent data transmission, long battery life, low mobility address, etc., address the market segment representing Internet of things (IoT)/Internet of everything (IoE), envisioning connectivity of billions of devices.

The URLLC requirements, like low latency, high reliability, variable mobility, etc., address the market segment representing the industrial automation applications, vehicle-to-vehicle/vehicle-to-infrastructure communication, e.g., for autonomous vehicles.

In a 5G wireless communication system operating in higher frequency (mmWave) bands, a UE and a gNB communicate with each other using beamforming. More specifically, beamforming techniques are used to mitigate propagation path losses and to increase propagation distances for communication at higher frequency bands. Beamforming enhances transmission and reception performance using a high-gain antenna. Generally, beamforming may be classified into transmission (TX) beamforming performed in a transmitting end and reception (RX) beamforming performed in a receiving end. The TX beamforming generally increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is essentially not transmitted in a direction other than a directivity direction, signal interference acting on another receiving end is significantly decreased.

A receiving end can perform beamforming on an RX signal by using an RX antenna array. The RX beamforming increases the RX signal strength transmitted in a specific direction by allowing propagation to be concentrated in a specific direction, and excludes a signal transmitted in a direction other than the specific direction from the RX signal, thereby blocking an interference signal.

By using beamforming techniques, a transmitter can make plurality of transmit beam patterns of different directions. Each of these transmit beam patterns can also be referred as a TX beam.

A wireless communication system operating at a high frequency may use a plurality of narrow TX beams to transmit signals in a cell, as each narrow TX beam provides a coverage to a part of cell. The narrower the TX beam, the higher the antenna gain and hence the larger the propagation distance of signal transmitted using beamforming. A receiver can also make a plurality of RX beam patterns of different directions. Each of these receive patterns can also be referred as an RX beam.

Carrier Aggregation (CA)/Multi-Connectivity in a 5G Wireless Communication System

A 5G wireless communication system supports standalone modes of operation as well dual connectivity (DC). In DC, a multiple Rx/Tx UE may be configured to utilize resources provided by two different nodes (or NB s) connected via a non-ideal backhaul. One node acts as a master node (MN) and the other as a secondary node (SN). The MN and SN are connected via a network interface and at least the MN is connected to a core network (CN).

NR also supports multi-radio access technology (RAT) DC (MR-DC) operations, whereby a UE in an RRC_CONNECTED state is configured to utilize radio resources provided by two distinct schedulers, located in two different nodes, connected via a non-ideal backhaul and providing either evolved-universal terrestrial mobile communications system (UMTS) radio access (E-UTRA) (i.e., if the node is an ng-eNB) or NR access (i.e., if the node is a gNB). In NR, for a UE in an RRC_CONNECTED state not configured with CA/DC, there is only one serving cell, i.e., a primary cell (PCell). For a UE in an RRC_CONNECTED state configured with CA/DC, the terminology “serving cells” is used to denote a set of cells including special cells (SpCells) and secondary cells (SCells). In NR the term master Cell Group (MCG) refers to a group of serving cells associated with the MN, comprising of the PCell and optionally one or more SCells. In NR, the term SCell group (SCG) refers to a group of serving cells associated with the SN, including a primary SCell (PSCell) and possibly one or more SCells.

In NR, a PCell refers to a serving cell in the MCG, operating on the primary frequency, in which the UE either performs an initial connection establishment procedure or initiates a connection re-establishment procedure.

In NR, for a UE configured with CA, an SCell provides additional radio resources on top of an SpCell. A PSCell refers to a serving cell in an SCG in which the UE performs random access (RA) when performing a reconfiguration with a sync procedure. For DC operations, an SpCell refers to a PCell of an MCG or a PSCell of an SCG. Otherwise, the SpCell refers to a PCell.

System Information (SI) Acquisition in a 5G Wireless Communication System

In a 5G wireless communication system, an NB (gNB) or BS in a cell broadcasts a synchronization signal (SS) and a physical broadcast channel (PBCH) block (SSB) including a primary SS (PSS), a secondary SS (SSS), and SI. The SI includes common parameters for communicating in the cell.

In a 5G wireless communication system, SI may divided into a master information block (MIB) and a number of SI blocks (SIBs).

An MIB is always transmitted on a broadcast channel (BCH) with a periodicity of 80 ms and repetitions for the MIB are made within 80 ms. The MIB includes parameters for acquiring an SIB1 from the cell.

The SIB1 is transmitted on a downlink (DL)-shared channel (SCH) with a periodicity of 160 ms and variable transmission repetition. A default transmission repetition periodicity of SIB1 is 20 ms, but the actual transmission repetition periodicity may be decide according to network implementation. The scheduling information in SIB 1 includes mapping between SIBs and SI messages, a periodicity of each SI message, and an SI window length. The scheduling information in SIB1 includes, for each SI message, an indicator of whether the concerned SI message is being broadcasted or not. If at least one SI message is not being broadcasted, the SIB1 may include RA resources (e.g., physical RA channel (PRACH) preamble(s) and PRACH resource(s)) for requesting a gNB to broadcast one or more SI messages.

SIBs other than SIB1 are carried in SI messages, which are transmitted on the DL-SCH. Only SIBs having the same periodicity can be mapped to the same SI message. Each SI message is transmitted within periodically occurring time domain windows (referred to as SI-windows) with same length for all SI messages. Each SI message is associated with an SI-window and the SI-windows of different SI messages do not overlap. That is, within one SI-window, only the corresponding SI message is transmitted. Any SIB, except SIB 1, can be configured to be cell specific or area specific, by using an indication in the SIB 1. The cell specific SIB is applicable only within a cell that provides the SIB while the area specific SIB is applicable within an area referred to as an SI area, which includes one or several cells and is identified by systemInformationAreaID.

Physical DL Control Channel (PDCCH) in a 5G Wireless Communication System

In a 5G wireless communication system, a PDCCH is used to schedule DL transmissions on a physical DL shared channel (PDSCH) and UL transmissions on a physical uplink (UL) shared channel (PUSCH).

DL control information (DCI) on the PDCCH includes DL assignments including at least a modulation and coding format, resource allocation, and hybrid-automatic repeat request (HARQ) information related to a DL-SCH, and UL scheduling grants including at least a modulation and coding format, resource allocation, and HARQ information related to a UL-SCH.

In addition to scheduling, a PDCCH can be used to for activation and deactivation of configured PUSCH transmission with a configured grant (CG), activation and deactivation of PDSCH semi-persistent transmission, notifying one or more UEs of the slot format, notifying one or more UEs of physical resource blocks (PRBs) and orthogonal frequency division multiplexing (OFDM) symbols, where the UE may assume no transmission is intended for the UE, transmission of transmission power control (TPC) commands for a physical UL control channel (PUCCH) and a PUSCH, transmission of one or more TPC commands for sounding reference signal (SRS) transmissions by one or more UEs, switching a UE's active BWP, and initiating an RA procedure.

A UE monitors a set of PDCCH candidates in the configured monitoring occasions in one or more configured control resource sets (CORESETs) according to the corresponding search space configurations. A CORESET includes a set of PRBs with a time duration of 1 to 3 OFDM symbols. Resource element groups (REGs) and control channel elements (CCEs) are defined within a CORESET with each CCE including a set of REGs.

Control channels are formed by aggregation of CCEs. Different code rates for the control channels are realized by aggregating different numbers of CCEs. Interleaved and non-interleaved CCE-to-REG mappings are supported in a CORESET. Polar coding is used for a PDCCH. Each REG carrying a PDCCH carries its own demodulation reference signal (DMRS). Quadrature phase shift keying (QPSK) modulation is used for a PDCCH.

In a 5G wireless communication system, a list of search space configurations are signaled by a gNB for each configured BWP, wherein each search configuration is uniquely identified by an identifier (ID). An IF of a search space configuration to be used for a specific purpose such as paging reception, SI reception, or RA response (RAR) reception is explicitly signaled by a gNB.

In NR, a search space configuration includes parameters monitoring-periodicity-PDCCH-slot, monitoring-offset-PDCCH-slot, monitoring-symbols-PDCCH-within-slot, and duration. A UE determines PDCCH monitoring occasions within a slot using the parameters of the PDCCH monitoring periodicity (Monitoring-periodicity-PDCCH-slot), the PDCCH monitoring offset (monitoring-offset-PDCCH-slot), and the PDCCH monitoring pattern (monitoring-symbols-PDCCH-within-slot). PDCCH monitoring occasions are in slots x to x+duration, where the slot number x in a radio frame with a number y satisfies Equation (1).

(y*(number of slots in a radio frame)+x−monitoring-offset-PDCCH-slot)mod (monitoring-periodicity-PDCCH-slot)=0 (1)

The starting symbol of a PDCCH monitoring occasion in each slot having a PDCCH monitoring occasion is given by monitoring-symbols-PDCCH-within-slot. The length (in symbols) of a PDCCH monitoring occasion is given in the CORESET associated with the search space. The search space configuration includes an ID of a CORESET configuration associated with it. A list of CORESET configurations are signaled by a gNB for each configured BWP, wherein each CORESET configuration is uniquely identified by an ID. Each radio frame has a 10 ms duration. A radio frame is identified by a radio frame number or system frame number.

Each radio frame includes several slots, wherein the number of slots in a radio frame and the duration of slots depend on an SCS. More specifically, the number of slots in the radio frame and the duration of slots depends a radio frame for each SCS, which is pre-defined. For example, for an SCS of 15 KHz, there are 10 slots in a radio frame and a duration of each slot is 1 ms. For an SCS of 30 KHz, there are 20 slots in a radio frame and a duration of each slot is 0.5 ms. For an SCS of 60 KHz, there are 40 slots in a radio frame and a duration of each slot is 0.25 ms. For an SCS of 120 KHz, there are 80 slots in a radio frame and a duration of each slot is 0.125 ms. For an SCS of 240 KHz, there are 160 slots in a radio frame and a duration of each slot is 0.0625 ms.

Each CORESET configuration is associated with a list of transmission configuration indicator (TCI) states. One DL reference signal (RS) ID (e.g., an SSB or a channel state information (CSI)-RS) is configured per TCI state. The list of TCI states corresponding to a CORESET configuration is signaled by a gNB via RRC signaling. One of the TCI states in the TCI state list is activated and indicated to a UE by a gNB. The TCI state indicates a DL TX beam (e.g., a DL TX beam is quasi-co located (QCLed) with an SSB/CSI-RS of the TCI state) used by a gNB for transmission of a PDCCH in a PDCCH monitoring occasions of a search space.

BWP Operation in a 5G Wireless Communication System

In a 5G wireless communication system, bandwidth adaptation (BA) is supported. With BA, the receiving and transmitting bandwidth of a UE should be less than the bandwidth of the cell and can be adjusted. The width can be ordered to change (e.g., to lessen during a period of low activity to save power). The location can move in the frequency domain (e.g., to increase scheduling flexibility). additionally, the SCS can be ordered to change (e.g., to allow different services).

A subset of a total cell bandwidth of a cell is referred to as a BWP. BA is achieved by configuring an RRC connected UE with BWPs and notifying the UE of which of the configured BWPs is currently the active one. When BA is configured, the UE only has to monitor a PDCCH on the active BWP, i.e., it does not have to monitor PDCCHs on the entire DL frequency of the serving cell.

In an RRC connected state, the UE is configured with one or more DL and UL BWPs for each configured serving cell (i.e., PCell or SCell). For an activated serving cell, there is always one active UL and DL BWP at any point in time. The BWP switching for a serving cell is used to activate an inactive BWP and deactivate an active BWP at a time. The BWP switching is controlled by the PDCCH indicating a DL assignment or a UL grant, by a bwp-InactivityTimer, by RRC signaling, or by a medium access control (MAC) entity itself, upon initiation of an RA procedure.

Upon addition of an SpCell or activation of an SCell, the DL BWP and UL BWP indicated by firstActiveDownlinkBWP-Id and firstActiveUplinkBWP-Id, respectively, are active without receiving a PDCCH indicating a DL assignment or a UL grant. The active BWP for a serving cell is indicated by either an RRC or a PDCCH. For unpaired spectrum, a DL BWP is paired with a UL BWP, and BWP switching is common for both UL and DL.

Upon expiry of a BWP inactivity timer, the UE switches from a currently active DL BWP to a default DL BWP or an initial DL BWP (e.g., if the default DL BWP is not configured).

RA in a 5G Wireless Communication System

In a 5G wireless communication system, RA is supported. RA is used to achieve UL time synchronization. RA is used during initial access, handover, RRC connection re-establishment procedure, scheduling request (SR) transmission, SCG addition/modification, beam failure recovery, and data or control information transmission in a UL by a non-synchronized UE in an RRC CONNECTED state.

Contention Based RA (CBRA) (or 4 Step CBRA)

In CBRA, a UE first transmits an RA preamble (referred to as Msg1) and then waits for an RAR in an RAR window. RAR is also referred as Msg2.

A gNB transmits the RAR on a PDSCH. A PDCCH scheduling the PDSCH carrying the RAR is addressed to an RA-radio network temporary identifier (RA-RNTI). The RA-RNTI identifies the time-frequency resource (also referred as a PRACH occasion, a PRACH transmission occasion, or an RA channel (RACH) occasion) in which an RA preamble was detected by a gNB.

The RA-RNTI is calculated using Equation (2).

RA-RNTI=1+s_id+14*t_id+14*80*f_id+14*80*8*ul_carrier_id (2)

In Equation (2), s_id is an index of a first OFDM symbol of a PRACH occasion where the UE has transmitted Msg1, i.e., an RA preamble, (0≤s_id<14); t_id is an index of a first slot of the PRACH occasion (0<t_id<80); f_id is an index of the PRACH occasion within the slot in the frequency domain (0<f_id<8), and ul_carrier_id is a UL carrier used for Msg1 transmission (0 for normal UL (NUL) carrier and 1 for supplementary UL (SUL) carrier).

Several RARs for various RA preambles detected by a gNB can be multiplexed in the same RAR MAC protocol data unit (PDU) by a gNB. An RAR in a MAC PDU corresponds to a UE's RA preamble transmission if the RAR includes an RA preamble ID (RAPID) of an RA preamble transmitted by the UE. If the RAR corresponding to its RA preamble transmission is not received during the RAR window and the UE has not yet transmitted the RA preamble for a configurable number of times (configured by a gNB in a RACH configuration), the UE goes back to a first step, i.e., selects an RA resource (preamble/RACH occasion) and transmits the RA preamble. A backoff may be applied before going back to first step.

If the RAR corresponding to its RA preamble transmission is received, the UE transmits message 3 (Msg3) in a UL grant received in the RAR. Msg3 includes an RRC connection request, an RRC connection re-establishment request, an RRC handover confirm, an SR, an SI request, etc. Msg3 may include the UE identity (i.e., cell-RNTI (C-RNTI) or system architecture evolution (SAE)-temporary mobile subscriber identity (S-TMSI) or a random number).

After transmitting the Msg3, the UE starts a contention resolution timer.

While the contention resolution timer is running, if the UE receives a PDCCH addressed to a C-RNTI included in Msg3, contention resolution is considered successful, the contention resolution timer is stopped, and the RA procedure is successfully completed. While the contention resolution timer is running, if the UE receives a contention resolution MAC control element (CE) including the UE's contention resolution identity (e.g., the first X bits of a common control channel (CCCH) service data unit (SDU) transmitted in Msg3), contention resolution is considered successful, the contention resolution timer is stopped, and the RA procedure is successfully completed.

If the contention resolution timer expires and the UE has not yet transmitted the RA preamble for a configurable number of times, the UE goes back to first step, i.e., selects RA resource (preamble/RACH occasion) and transmits the RA preamble. A backoff may be applied before going back to the first step.

Contention Free RA (CFRA) (Legacy CFRA or 4 Step CFRA)

A CFRA procedure is used for scenarios such as handover, where low latency is required, timing advance establishment for SCell, etc. An eNB assigns a dedicated RA preamble to the UE. The UE transmits the dedicated RA preamble. The eNB transmits the RAR on a PDSCH addressed to an RA-RNTI. The RAR conveys a RAPID and timing alignment information. The RAR may also include a UL grant. The RAR is transmitted in an RAR window similar to CBRA procedure. CFRA is considered successfully completed after receiving the RAR including a RAPID of the RA preamble transmitted by the UE. In case the RA is initiated for beam failure recovery, CFRA is considered successfully completed if the PDCCH addressed to the C-RNTI is received in a search space for beam failure recovery. If the RAR window expires, the RA is not successfully completed, and the UE has not yet transmitted the RA preamble for a configurable number of times (e.g., configured by a gNB in a RACH configuration), the UE retransmits the RA preamble.

For certain events, such has handover and beam failure recovery, if dedicated preamble(s) are assigned to the UE, during a first step of RA, i.e., during RA resource selection for Msg1 transmission, the UE determines whether to transmit dedicated preamble or non-dedicated preamble. Dedicated preambles are typically provided for a subset of SSBs/CSI-RSs. If there is no SSB/CSI RS having a DL RS received power (RSRP) above a threshold amongst the SSB s/CSI RSs for which CFRA resources (i.e., dedicated preambles/RACH occasions (ROs)) are provided by a gNB, the UE selects a non-dedicated preamble. Otherwise, the UE selects the dedicated preamble. Accordingly, during the RA procedure, one RA attempt can be CFRA, while another RA attempt can be CBRA.

2 Step CBRA

In a first step, a UE transmits an RA preamble on a PRACH and a payload (i.e., a MAC PDU) on a PUSCH. The RA preamble and payload transmission is also referred as MsgA.

In a second step, after MsgA transmission, the UE monitors for a response from the network (i.e., a gNB) within a configured window. The response is also referred as MsgB. A gNB transmits the MsgB on a PDSCH. A PDCCH scheduling the PDSCH carrying MsgB is addressed to MSGB-RNTI. MSGB-RNTI identifies the time-frequency resource (also referred to as a PRACH occasion, a PRACH transmission occasion, or a RACH occasion) in which an RA preamble was detected by a gNB.

The MSGB-RNTI is calculated using Equation (3).

MSGB-RNTI=1+s_id+14*t_id+14*80*f_id+14*80*8*ul_carrier_id+14×80×8×2 (3)

In Equation (3), s_id is an index of a first OFDM symbol of the PRACH occasion where the UE has transmitted Msg1, i.e., an RA preamble, (0≤s_id<14); t_id is an index of the first slot of the PRACH occasion (0<t_id<80); f_id is an index of the PRACH occasion within the slot in the frequency domain (0<f_id<8); and ul_carrier_id is the UL carrier used for Msg1 transmission (0 for NUL carrier and 1 for SUL carrier).

If a CCCH SDU was transmitted in MsgA payload, the UE performs contention resolution using the contention resolution information in MsgB. The contention resolution is successful if the contention resolution ID received in MsgB matches the first 48 bits of the CCCH SDU transmitted in MsgA. If a C-RNTI was transmitted in MsgA payload, the contention resolution is successful if the UE receives a PDCCH addressed to the C-RNTI. If contention resolution is successful, the RA procedure is considered successfully completed. Instead of contention resolution information corresponding to the transmitted MsgA, MsgB may include fallback information corresponding to the RA preamble transmitted in MsgA. If the fallback information is received, the UE transmits

Msg3 and performs contention resolution using Msg4 as in a CBRA procedure. If contention resolution is successful, the RA procedure is considered successfully completed. If contention resolution fails upon fallback (i.e., upon transmitting Msg3), the UE retransmits MsgA. If a configured window in which the UE monitors a network response after transmitting MsgA expires and the UE has not received MsgB including contention resolution information or fallback information as described above, the UE retransmits MsgA. If the RA procedure is not successfully completed, even after transmitting the MsgA configurable number of times, the UE fallbacks to 4 step RACH procedure, i.e., the UE only transmits the PRACH preamble.

MsgA payload may include one or more of a CCCH SDU, a dedicated control channel (DCCH) SDU, a dedicated traffic channel (DTCH) SDU, a buffer status report (BSR) MAC CE, a power headroom report (PHR) MAC CE, SSB information, a C-RNTI MAC CE, or padding. MsgA may include a UE ID (e.g., a random ID, an S-TMSI, a C-RNTI, a resume ID, etc.) along with a preamble in the first step. The UE ID may be included in the MAC PDU of the MsgA. The UE ID, such as a C-RNTI, may be carried in a MAC CE, which is included in a MAC PDU. Other UE IDs (such random ID, S-TMSI, C-RNTI, resume ID, etc.) may be carried in a CCCH SDU. The UE ID can be one of a random ID, an S-TMSI, a C-RNTI, a resume ID, an international mobile subscriber ID (IMSI), an idle mode ID, an inactive mode ID, etc. The UE ID can be different in different scenarios of performing the RA procedure. When UE performs RA after power is on (before it is attached to the network), then UE ID is the random ID. When UE performs RA in an IDLE state after it is attached to network, the UE ID is an S-TMSI. If UE has an assigned C-RNTI (e.g., in a connected state), the UE ID is the C-RNTI. In case the UE is in an RRC_INACTIVE state, the UE ID is a resume ID.

In addition to a UE ID, some additional control information can be sent in MsgA. The control information may be included in the MAC PDU of the MsgA. The control information may include one or more of a connection request indication, a connection resume request indication, an SI request indication, a buffer status indication, beam information (e.g., one or more DL TX beam ID(s) or SSB ID(s)), beam failure recovery indication/information, a data indicator, a cell/BS/transmission and reception point (TRP) switching indication, a connection re-establishment indication, a reconfiguration complete or handover complete message, etc.

2 Step CFRA

In 2 step CFRA, a gNB assigns dedicated RA preambles and PUSCH resources for MsgA transmission to a UE. ROs to be used for preamble transmission may also be indicated.

In a first step, the UE transmits RA preamble on a PRACH and a payload on a PUSCH using the CFRA resources (i.e., dedicated preamble/PUSCH resource/RO).

In a second step, after MsgA transmission, the UE monitors for a response from the network (i.e., a gNB) within a configured window. The response is also referred as MsgB.

A gNB transmits the MsgB on a PDSCH. A PDCCH scheduling the PDSCH carrying MsgB is addressed to MSGB-RNTI. The MSGB-RNTI identifies the time-frequency resource (also referred as a PRACH occasion, a PRACH transmission occasion, or a RACH occasion) in which an RA preamble was detected by a gNB. The MSGB-RNTI is calculated using Equation (3), as shown above.

If a UE receives a PDCCH addressed to a C-RNTI, the RA procedure is considered successfully completed. If the UE receives fallback information corresponding to its transmitted preamble, the RA procedure is considered successfully completed.

For certain events such has handover and beam failure recovery, if dedicated preambles and PUSCH resources are assigned to the UE during the first step of RA, i.e., during RA resource selection for MsgA transmission, the UE determines whether to transmit a dedicated preamble or a non-dedicated preamble. Dedicated preambles are typically provided for a subset of SSBs/CSI RSs. If there is no SSB/CSI RS having a DL RSRP above a threshold amongst the SSBs/CSI RSs for which CFRA resources (i.e., dedicated preambles/ROs/PUSCH resources) are provided by a gNB, the UE selects the non-dedicated preamble. Otherwise, the UE selects the dedicated preamble. Accordingly, during the RA procedure, one RA attempt can be a 2 step CFRA, while another RA attempt can be a 2 step CBRA.

Upon initiation of an RA procedure, the UE first selects the carrier (SUL or NUL). If the carrier to use for the RA procedure is explicitly signaled by a gNB, the UE selects the signaled carrier for performing RA procedure. If the carrier to use for the RA procedure is not explicitly signaled by the gNB; and if the serving cell for the RA procedure is configured with supplementary UL and if the RSRP of the DL pathloss reference is less than rsrp-ThresholdSSB-SUL, the UE selects the SUL carrier for performing RA procedure. Otherwise, the UE selects the NUL carrier for performing the RA procedure.

Upon selecting the UL carrier, the UE determines the UL BWP and DL BWP for RA procedure as specified in section 5.15 of TS 38.321. The UE then determines whether to perform the 2 step RACH or 4 step RACH for this RA procedure.

If the RA procedure is initiated by a PDCCH order and if the ra-PreambleIndex explicitly provided by the PDCCH is not 0b000000, the UE selects 4 step RACH.

If 2 step CFRA resources are signaled by a gNB for the RA procedure, the UE selects 2 step RACH.

If 4 step CFRA resources are signaled by the gNB for the RA procedure, the UE selects 4 step RACH.

If the UL BWP selected for the RA procedure is configured with only 2 step RACH resources, the UE selects 2 step RACH.

If the UL BWP selected for this RA procedure is configured with only 4 step RACH resources, the UE selects 4 step RACH.

If the UL BWP selected for this RA procedure is configured with both 2 step and 4 step RACH resources, and RSRP of the DL pathloss reference is below a configured threshold, the UE selects 4 step RACH. Otherwise, the UE selects 2 step RACH.

In a 5G wireless communication system, the UE can be in an RRC IDLE state, an RRC INACTIVE state, or an RRC CONNECTED state.

In an RRC_IDLE state, a UE specific discontinuous reception (DRX) may be configured by upper layers (i.e., non-access stratum (NAS)). The UE in an RRC_IDLE state monitors short messages transmitted with a paging-RNTI (P-RNTI) over DCI, monitors a paging channel for CN paging using a 5G-S-TMSI, performs neighboring cell measurements and cell selection (or reselection), acquires SI, and can send an SI request (if configured).

In an RRC_INACTIVE state, a UE specific DRX may be configured by upper layers or by an RRC layer. In this state, the UE stores the UE inactive access stratum (AS) context. A radio access network (RAN)-based notification area (RNA) is configured by the RRC layer. The UE, in the RRC_INACTIVE state, monitors short messages transmitted with a P-RNTI over DCI, monitors a paging channel for CN paging using 5G-S-TMSI and RAN paging using full inactive-RNTI (fullI-RNTI), performs neighboring cell measurements and cell (re-)selection, performs RAN-based notification area updates periodically and when moving outside the configured RAN-based notification area, acquires SI, and can send SI request (if configured).

In the RRC_CONNECTED state, the UE stores the AS context. Unicast data is transmitted/received to/from the UE. At lower layers, the UE may be configured with a

UE specific DRX. The UE in the RRC_CONNECTED state, monitors short messages transmitted with a P-RNTI over DCI, if configured, monitors control channels associated with the shared data channel to determine if data is scheduled for it, provides channel quality and feedback information. performs neighboring cell measurements and measurement reporting, and acquires SI.

The 5G or next generation RAN (NG-RAN) based on NR includes NG-RAN nodes, where an NG-RAN node is a gNB, providing NR user plane and control plane protocol terminations towards the UE. The gNBs are also connected by NG interfaces to the SGC, i.e., to an access and mobility management function (AMF) by the NG-C interface and to a user plane function (UPF) by the NG-U interface.

In a 5G wireless communication system, the UE may use DRX in an RRC_IDLE state and an RRC_INACTIVE state in order to reduce power consumption. In the RRC_IDLE/RRC_INACTIVE state, the UE wakes up at regular intervals (i.e., every DRX cycle) for short periods to receive paging, to receive SI update notification, and to receive emergency notifications.

A paging message is transmitted using a PDSCH. A PDCCH is addressed to a P-RNTI if there is a paging message in the PDSCH. The P-RNTI is common for all UEs. A UE ID (i.e., an S-TMSI for an RRC_IDLE UE or an I-RNTI for an RRC_INACTIVE UE) is included in a paging message to indicate paging for a specific UE. The paging message may include multiple UE identities to page multiple UEs. The paging message is broadcasted (i.e., a PDCCH is masked with a P-RNTI) over a data channel (i.e., a PDSCH). An SI update and emergency notifications are included in DCI and a PDCCH carrying the DCI is addressed to the P-RNTI.

In the RRC idle/inactive mode, the UE monitors one paging occasion (PO) for every DRX cycle. In the RRC idle/inactive mode, the UE monitors a PO in an initial DL BWP. In an RRC connected state, the UE monitors one or more POs to receive an SI update notification and to receive emergency notifications. In the RRC connected state, the UE can monitor any PO in paging DRX cycle and monitors at least one PO in an SI modification period. In the RRC idle/inactive mode, the UE monitors a PO for every DRX cycle in its active DL BWP. A PO is a set of ‘S’ PDCCH monitoring occasions for paging, where ‘S’ is the number of transmitted SSBs (i.e., the SSB includes (PSS, SSS, and a PBCH) in a cell. The UE first determines the paging frame (PF) and then determines the PO with respect to the determined PF. One PF is a radio frame (10 ms).

SDT in a 5G Wireless Communication System

SDT is a procedure allowing data and/or signaling transmission while remaining in an RRC_INACTIVE state (i.e., without transitioning to an RRC_CONNECTED state). SDT is enabled on a radio bearer basis and is initiated by the UE only if UL data available for transmission across all radio bearers for which SDT is enabled is less than a configured amount of UL data, the DL RSRP is above a configured threshold, and a valid SDT resource is available.

The SDT procedure is initiated with either a transmission over a RACH (configured via SI) or over Type 1 CG resources (configured via a dedicated signaling of an RRCRelease message). The SDT resources can be configured on an initial BWP for both a RACH and a CG. The RACH and CG resources for SDT can be configured on either or both of NUL and SUL carriers. The CG resources for SDT are valid only within the cell where the UE received an RRCRelease message and transitioned to an RRC_INACTIVE state. For a RACH, the network can configure 2-step and/or 4-step RA resources for SDT. When both 2-step and 4-step RA resources for SDT are configured, the UE selects the RA type. CFRA is not supported for SDT over RACH.

Once initiated, the SDT procedure is successfully completed after the UE is directed to RRC_IDLE (via RRCRelease) or RRC_INACTIVE (via RRCRelease or RRCReject) or to RRC_CONNECTED (via RRCResume or RRCSetup), or unsuccessfully completed, upon cell re-selection, expiry of the SDT failure detection timer (also referred as T319a), a MAC entity reaching a configured maximum PRACH preamble transmission threshold, an RLC entity reaching a configured maximum retransmission threshold, or expiry of an SDT-specific timing alignment timer while an SDT procedure is ongoing over a CG and the UE has not received a response from the network after the initial PUSCH transmission.

Upon unsuccessful completion of the SDT procedure, the UE transitions to RRC_IDLE.

The initial PUSCH transmission during the SDT procedure includes at least the CCCH message. After the SDT procedure is initiated, the UE starts the SDT failure detection timer when the UE first transmits the MAC PDU including the CCCH message. When using CG resources for an initial SDT transmission, the UE can perform autonomous retransmission of the initial transmission if the UE does not receive confirmation from the network (dynamic UL grant or DL assignment) before a configured timer expires. After the initial PUSCH transmission, subsequent transmissions are handled differently depending on the type of resource used to initiate the SDT procedure.

When using CG resources, the network can schedule subsequent UL transmissions using dynamic grants or subsequent UL transmissions can take place on the following CG resource occasions. The DL transmissions are scheduled using dynamic assignments. The UE can initiate subsequent UL transmission only after reception of confirmation (dynamic UL grant or DL assignment) for the initial PUSCH transmission from the network. For subsequent UL transmission, the UE cannot initiate re-transmission over a CG resource.

When using RACH resources, the network can schedule subsequent UL and DL transmissions using dynamic UL grants and DL assignments, respectively, after the completion of the RA procedure.

While the SDT procedure is ongoing, if data appears in a buffer of any radio bearer not enabled for SDT, the UE initiates a transmission of a non-SDT data arrival indication using UEAssistanceInformation message to the network and, if available, includes the resume cause.

An SDT procedure over CG resources can only be initiated with valid UL timing alignment. The UL timing alignment is maintained by the UE based on an SDT-specific timing alignment timer configured by the network via dedicated signaling and DL RSRP of configured number of highest ranked SSBs, which are above a configured RSRP threshold, is also configured for initial CG-SDT transmission. Upon expiry of the SDT-specific timing alignment timer (cg-SDT-TimeAlignmentTirrter), the CG resources are released while maintaining the CG resource configuration.

Logical channel restrictions configured by the network while in RRC_CONNECTED state and/or in RRCRelease message for radio bearers enabled for SDT, if any, are applied by the UE during SDT procedure.

The network may configure the UE to apply robust header compression (ROHC) continuity for SDT when the UE initiates SDT in the cell where the UE received RRCRelease message and transitioned to RRC_INACTIVE state, or when the UE initiates SDT in a cell of its RAN notification area (RNA).

Multicast reception in a 5G wireless communication system A multicast communication service is delivered to the UEs using a multicast session. A UE can receive a multicast communication service in an RRC_CONNECTED state with mechanisms such as point to point (PTP) and/or point to multi-point (PTM) delivery. HARQ feedback/retransmission can be applied to both PTP transmission and PTM transmission. For a multicast session, a gNB provides multicast MBS radio bearer (MRB) configurations to the UE via dedicated RRC signaling. If the UE that joined a multicast session is in RRC_CONNECTED state and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

When there is (temporarily) no data to be sent to the UEs for a multicast session, the gNB may move the UE to an RRC_IDLE/RRC_INACTIVE state. The gNBs supporting MBS use a group notification mechanism to notify the UEs in an RRC_IDLE/RRC_INACTIVE state when a multicast session has been activated by the CN or the gNB has multicast session data to deliver. Upon reception of the group notification, the UEs reconnect to the network, i.e., the UEs initiated connection setup/resumption and enters RRC_CONNECTED. The group notification is addressed with a P-RNTI on a PDCCH.

According to a current operation for MBS multicast reception, a UE monitors a paging channel for paging using a TMGI. If the UE receives the paging message upon monitoring the paging channel, it may initiate an RRC connection resumption procedure as per following:
1> if UE is in an RRC_INACTIVE state and the UE has joined one or more MBS session(s) indicated by the TMGI included in the pagingGroupList; and
1> if none of the ue-Identity included in any of the PagingRecord, if included in the Paging message, matches the UE identity allocated by upper layers:
   2> initiate the RRC connection resumption procedure

An SDT procedure can be initiated in an RRC_INACTIVE state. As per current operations, irrespective of whether an SDT procedure is ongoing or not, the UE in an RRC_INACTIVE state monitors paging channel for paging using a TMGI. The consequence is that in case paging for MBS is received, a resume procedure can be triggered in the middle of an ongoing SDT procedure. In case paging for MBS is never sent by network during SDT, paging monitoring is unnecessary and leads to increased power consumption.

In this disclosure, various embodiments for resolving the above issues are.

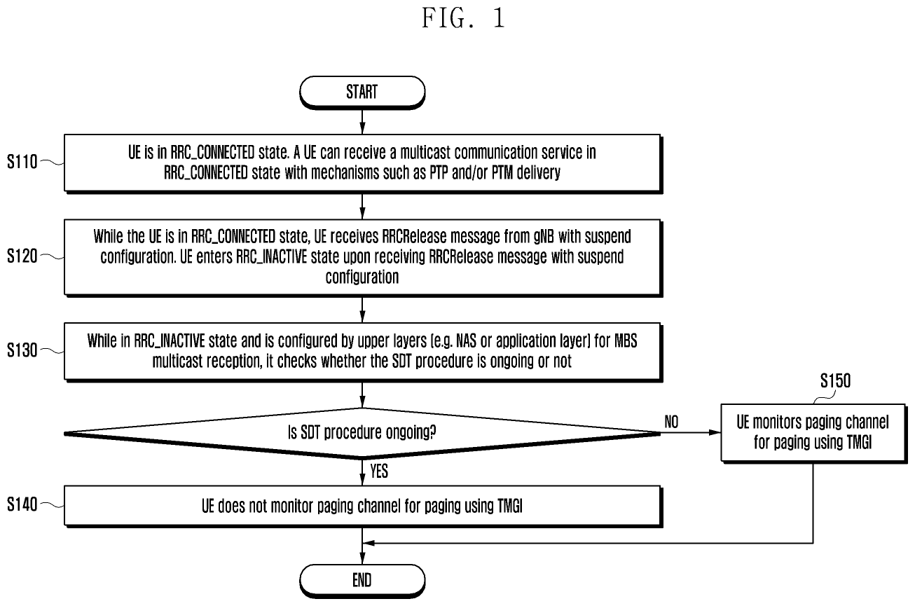

FIG. 1 is a flow chart illustrating a UE operation according to an embodiment.

Referring to FIG. 1, in step S110, the UE, an RRC_CONNECTED state, receives a multicast communication service with mechanisms such as a PTP and/or PTM delivery.

For a multicast session, a gNB provides multicast MRB configuration(s) to the UE via dedicated RRC signaling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

In step S120, while the UE is in RRC_CONNECTED state, the UE receives an RRCRelease message from the gNB with a suspend configuration, and then enters RRC_INACTIVE state.

While the UE is in an RRC_INACTIVE state, an SDT procedure may be initiated as above. In step S130, if the UE is in the RRC_INACTIVE state and if configured by upper layers (e.g., NAS or application layer) for MBS multicast reception (or for MBS multicast reception in RRC_CONNECTED), the UE checks whether the SDT procedure is ongoing or not.

If the SDT procedure is ongoing in step S130, the UE does not monitor paging channel for paging using TMGI, and will not receive PDSCH for paging in step S140.

However, if the SDT procedure is not ongoing in step S130, the UE monitors paging channel for paging using the TMGI in step S150.

If the UE is in an RRC_INACTIVE state and if configured by upper layers (e.g., NAS or application layer) for MBS multicast reception in an RRC_INACTIVE state, the UE monitors paging channel for paging using TMGI.

Alternatively, if the UE is in an RRC_INACTIVE state and if configured by upper layers (e.g., a NAS or application layer) for MBS multicast reception (or for MBS multicast reception in RRC_CONNECTED), it checks whether the timer (e.g., a T319a timer) is running or not. If the timer is running, the UE does not monitor a paging channel for paging using a TMGI, and the UE will not receive PDSCH for paging. If the timer is not running, the UE monitors paging channel for paging using the TMGI. The timer may be started when the UE initiates the SDT procedure or it may be started when a first UL transmission including CCCH message during the SDT procedure is transmitted, when RA procedure initiated for SDT procedure is successfully completed, or when network response (i.e., a PDCCH addressed to a C-RNTI) for a first UL transmission including a CCCH message is received from a network (i.e., a gNB).

Alternatively, while the UE is in an RRC_INACTIVE state, an SDT procedure may be initiated as explained earlier. If the UE is in an RRC_INACTIVE state and if configured by upper layers (e.g., a NAS or application layer) for MBS multicast reception (or for MBS multicast reception in RRC_CONNECTED), it checks whether the timer is running or not. If the timer is running, the UE may determine whether an SDT or multicast reception has higher priority. The priority may be indicated by network in SI, RRC signaling, or pre-defined. If the priority of MBS multicast reception is higher than the priority of the SDT, the UE monitors a paging channel for paging using the TMGI. If the priority of MBS multicast reception is lower than the priority of SDT, the UE does not monitor the paging channel for paging using the TMGI. If the timer is not running, the UE monitors the paging channel for paging using the TMGI.

Alternatively, while the UE is in an RRC_INACTIVE state, an SDT procedure may be initiated as described above. If the UE is in an RRC_INACTIVE state and if configured by upper layers (e.g., a NAS or application layer) for MBS multicast reception (or for MBS multicast reception in RRC_CONNECTED), it checks whether the SDT procedure is ongoing or not. If the SDT procedure is ongoing, the UE may determine whether the SDT or multicast reception has higher priority. The priority may be indicated by network in SI, RRC signaling, or pre-defined. If the priority of MBS multicast reception is higher than the priority of SDT, the UE monitors paging channel for paging using TMGI. If the priority of MBS multicast reception is lower than the priority of SDT, the UE does not monitor paging channel for paging using the TMGI. If the SDT procedure is not ongoing, the UE monitors paging channel for paging using the TMGI.

If the UE receives a paging message upon monitoring a paging channel, it may initiate an RRC connection resumption procedure as per following:
1> if a UE is in an RRC_INACTIVE and the UE has joined one or more MBS session(s) indicated by the TMGI included in the pagingGroupList; and
1> if none of the ue-Identity included in any of the PagingRecord, if included in the Paging message, matches the UE identity allocated by upper layers:
   2> initiate the RRC connection resumption procedure

Alternatively,
1> if in RRC_INACTIVE and the UE has joined one or more MBS session(s) indicated by the TMGI included in the pagingGroupList; and
1> if none of the ue-Identity included in any of the PagingRecord, if included in the Paging message, matches the UE identity allocated by upper layers
   2> if multicast reception is supported in RRC_INACTIVE state (or if the UE has configuration for multicast reception in RRC_INACTIVE state and/or if gNB has indicated that it supports multicast reception in RRC_INACTIVE state by SI or RRC signaling (RRC Release or RRCReconfiguration):
      3> UE initiate procedure to receive multicast reception in RRC_INACTIVE (e.g. resume one or more MRB(s), establish/re-establish PDCP/RLC entity for the resumed MRBs, etc.)
   2> else:
      3> initiate the RRC connection resumption procedure with resume Cause set as below:
         4> if the UE is configured by upper layers with Access Identity 1:
         5> resumeCause is set to rnps-PriorityAccess;
         4> else if the UE is configured by upper layers with Access Identity 2:
         5> resumeCause is set to mcs-PriorityAccess;
         4> else if the UE is configured by upper layers with one or more Access Identities equal to 11-15:
         5> resumeCause is set to highPriorityAccess;
         4> else:
         5> resumeCause is set to mt-Access.

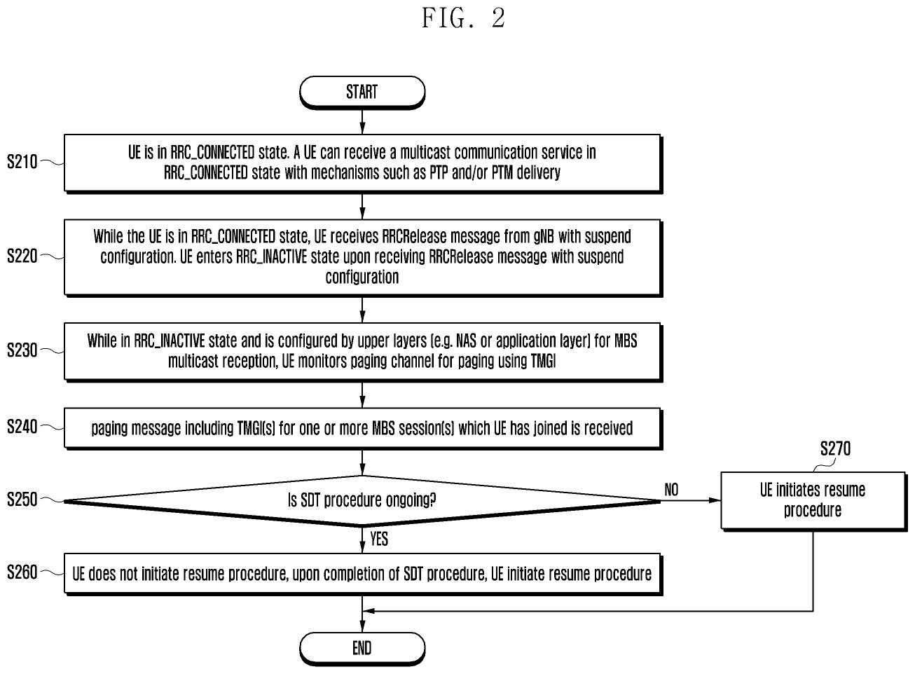

FIG. 2 is a flow chart illustrating a UE operation according to an embodiment.

Referring to FIG. 2, in step S210, a UE, in an RRC_CONNECTED state, receives a multicast communication service with mechanisms such as a PTP and/or PTM delivery.

For a multicast session, a gNB provides multicast MRB configurations to the UE via dedicated RRC signaling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

While the UE is in an RRC_CONNECTED state, the UE receives an RRCRelease message from a gNB with suspend configuration and enters RRC_INACTIVE state in step S220.

While the UE is in an RRC_INACTIVE state, an SDT procedure may be initiated as described above. If configured by upper layers (e.g., a NAS or application layer) for MBS multicast reception (or for MBS multicast reception in RRC_CONNECTED), the UE monitors a paging channel for paging using a TMGI in step S230.

If paging message including TMGI(s) for one or more MBS session(s) which UE has joined is received in step S240, the UE checks whether the SDT procedure is ongoing or not in step S250.

If the SDT procedure is ongoing in step S250, the UE does not initiate a resume procedure and the resume procedure is initiated by the UE upon completion of SDT procedure in step S260.

If the SDT procedure is not ongoing in step S250, the UE initiates the resume procedure in step 270.

Alternatively, if a paging message including TMGI(s) for one or more MBS session(s) which the UE has joined is received, it checks whether the timer (e.g., a T319a timer) is running or not. If the timer is running, the UE does not initiate resume procedure, and the resume procedure is initiated by the UE upon completion of an SDT procedure. If the timer is not running, the UE initiates the resume procedure. The timer may be started when the UE initiates the SDT procedure, it may be started when a first UL transmission including a CCCH message during the SDT procedure is transmitted, it may be started when an RA procedure initiated for the SDT procedure is successfully completed, or it may be started when network response (i.e., a PDCCH addressed to a C-RNTI) for the first UL transmission including a CCCH message is received from a network (i.e., gNB).

Alternatively, while the UE is in an RRC_INACTIVE state, an SDT procedure may be initiated as described above. If configured by upper layers (e.g., NAS or application layer) for MBS multicast reception (or for MBS multicast reception in RRC_CONNECTED), the UE monitors a paging channel for paging using a TMGI. If the paging message including the TMGI(s) for one or more MBS session(s) which the UE has joined is received, the UE checks whether the SDT procedure is ongoing or not. If the SDT procedure is ongoing, the UE may determine whether the SDT or multicast reception has higher priority. The priority may be indicated by a network in SI, RRC signaling, or pre-defined. If the priority of MBS multicast reception is lower than the priority of SDT, the UE does not initiate a resume procedure, and the resume procedure is initiated by the UE upon completion of SDT procedure. If the SDT procedure is not ongoing, the UE initiates the resume procedure.

Alternatively, while the UE is in an RRC_INACTIVE state, an SDT procedure may be initiated as described above. If configured by upper layers (e.g., a NAS or application layer) for MBS multicast reception (or for MBS multicast reception in RRC_CONNECTED), the UE monitors a paging channel for paging using a TMGI. If a paging message including TMGI(s) for one or more MBS session(s) which the UE has joined is received, the UE checks whether the timer is running or not. If the timer is running, the UE may determine whether the SDT or multicast reception has higher priority. The priority may be indicated by a network in SI, RRC signaling, or pre-defined. If the priority of MBS multicast reception is lower than the priority of SDT, the UE does not initiate a resume procedure, and the UE initiates the resume procedure upon completion of an SDT procedure. If the timer is not running, the UE initiates the resume procedure.

If the UE receives a paging message upon monitoring a paging channel:
1> if in an RRC_INACTIVE and the UE has joined one or more MBS session(s) indicated by the TMGI included in the pagingGroupList; and
1> if none of the ue-Identity included in any of the PagingRecord, if included in the Paging message, matches the UE identity allocated by upper layers; and
if T319a is not running:
   2> initiate the RRC connection resumption procedure according to 5.3.13 with resume Cause set as below:
      3> if the UE is configured by upper layers with Access Identity 1:
         4> resume Cause is set to mps-PriorityAccess;
      3> else if the UE is configured by upper layers with Access Identity 2:
         4> resume Cause is set to mcs-PriorityAccess;
      3> else if the UE is configured by upper layers with one or more Access Identities equal to 11-15:
         4> resume Cause is set to highPriorityAccess;
      3> else:
         4> resume Cause is set to mt-Access.

If a UE is in an RRC_INACTIVE state and the UE has joined one or more MBS session(s) indicated by the TMGI included in the pagingGroupList and if none of the ue-Identity included in any of the PagingRecord, if included in the Paging message, matches the UE identity allocated by upper layers and if T319a is running, the UE initiates the RRC connection resumption procedure upon completion of an SDT procedure (i.e., T319a is stopped while the UE is in an RRC_INACTIVE state).

Alternatively, if a UE receives a paging message upon monitoring a paging channel:
1> if in an RRC_INACTIVE and the UE has joined one or more MBS session(s) indicated by the TMGI included in the pagingGroupList; and
1> if none of the ue-Identity included in any of the PagingRecord, if included in the Paging message, matches the UE identity allocated by upper layers
   2> initiate the RRC connection resumption procedure according to 5.3.13 with resumeCause set after T319a is stopped while the UE is in RRC_INACTIVE state, as below:
      3> if the UE is configured by upper layers with Access Identity 1:
         4> resume Cause is set to mps-PriorityAccess;
      3> else if the UE is configured by upper layers with Access Identity 2:
         4> resume Cause is set to mcs-PriorityAccess;
      3> else if the UE is configured by upper layers with one or more Access Identities equal to 11-15:
         4> resume Cause is set to highPriorityAccess;
      3> else:
         4> resume Cause is set to mt-Access.

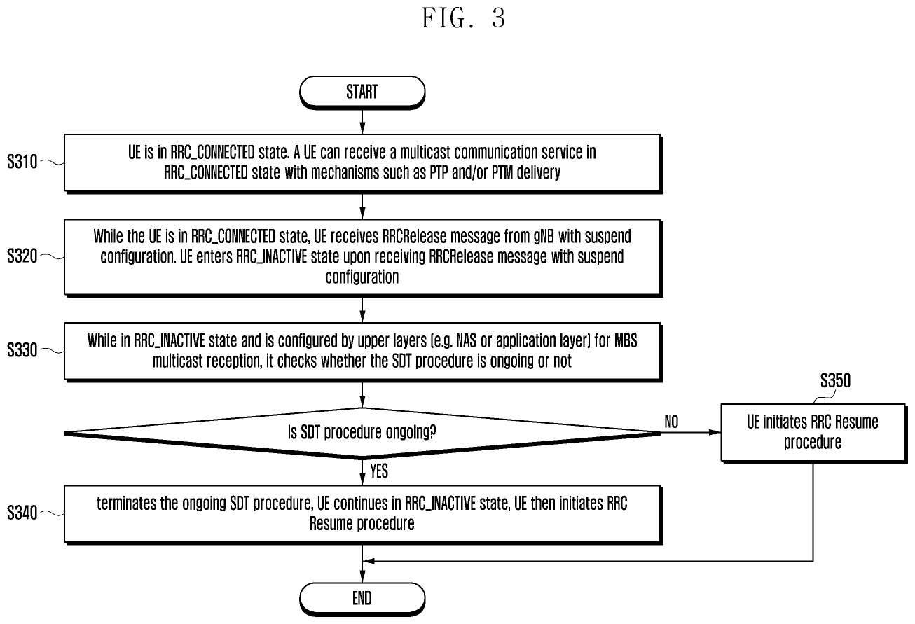

FIG. 3 is a flow chart illustrating a UE operation according to an embodiment.

Referring to FIG. 3, in step S310, a UE, in an RRC_CONNECTED state, receives a multicast communication service with mechanisms such as a PTP and/or PTM delivery.

For a multicast session, a gNB provides multicast MRB configuration(s) to the UE via dedicated RRC signaling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

While the UE is in RRC_CONNECTED state, the UE receives RRCRelease message from a gNB with a suspend configuration. The UE enters an RRC_INACTIVE state upon receiving RRCRelease message with suspend configuration in step S320.

While the UE is in an RRC_INACTIVE state, an SDT procedure may be initiated as described above. In step S330, if the UE is in an RRC_INACTIVE state and if configured by upper layers (e.g., a NAS or application layer) for MBS multicast reception (or for MBS multicast reception in RRC_CONNECTED), the UE checks whether the SDT procedure is ongoing or not.

If the SDT procedure is ongoing in step S330, the UE terminates the ongoing SDT procedure, continues in an RRC_INACTIVE state, and then initiates an RRC connection resumption procedure in step S340.

If the SDT procedure is not ongoing in step S330, the UE initiates the RRC connection resumption procedure in step S350.

Alternatively, if the UE is in an RRC_INACTIVE state and if configured by upper layers (e.g., a NAS or application layer) for MBS multicast reception, the UE checks whether the timer is running or not. If the timer is running, the UE terminates the ongoing SDT procedure, continues in RRC_INACTIVE state, and then initiates RRC connection resumption procedure. If the timer is not running, the UE initiates an RRC connection resumption procedure.

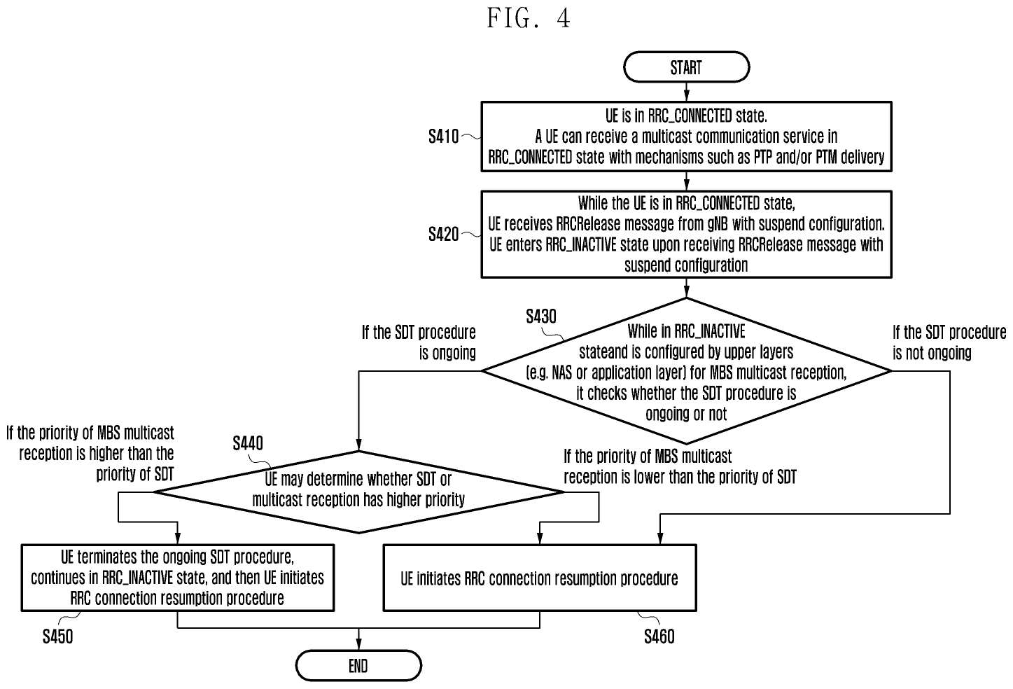

FIG. 4 is a flow chart illustrating a UE operation according to an embodiment.

Referring to FIG. 4, a UE, in an RRC_CONNECTED state, receives a multicast communication service in an RRC_CONNECTED state with mechanisms such as a PTP and/or PTM delivery in step S410.

For a multicast session, a gNB provides multicast MRB configuration(s) to the UE via dedicated RRC signaling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.

While the UE is in RRC_CONNECTED state, the UE receives an RRCRelease message from the gNB with a suspend configuration and enters an RRC_INACTIVE state in step S420.

While the UE is in RRC_INACTIVE state, an SDT procedure may be initiated as described above. If the UE is in an RRC_INACTIVE state and if configured by upper layers (e.g., a NAS or application layer) for MBS multicast reception (or for MBS multicast reception in RRC_CONNECTED), the checks whether the SDT procedure is ongoing or not in step S430.

If the SDT procedure is ongoing in step S430, the UE determines whether SDT or multicast reception has higher priority in step S440.

The priority may be indicated by a network in SI or RRC signaling. If the priority of MBS multicast reception is higher than the priority of SDT, the UE terminates the ongoing SDT procedure, continues in RRC_INACTIVE state, and then initiates an RRC connection resumption procedure in step S450.

If the priority of MBS multicast reception is lower than the priority of SDT in step S440, or if the SDT procedure is not ongoing in step S430, the UE initiates the RRC connection resumption procedure in step S460.

Alternatively, if the UE is in an RRC_INACTIVE state and if configured by upper layers (e.g., a NAS or application layer) for MBS multicast reception (or for MBS multicast reception in RRC_CONNECTED), the UE checks whether the timer is running or not. If the timer is running, the UE may determine whether SDT or multicast reception has higher priority. The priority may be indicated by network in SI or RRC signaling. If the priority of MBS multicast reception is higher than the priority of SDT, the UE terminates the ongoing SDT procedure, continues in RRC_INACTIVE state, and then initiates an RRC connection resumption procedure. If the priority of MBS multicast reception is lower than the priority of SDT or if the timer is not running, the UE initiates the RRC connection resumption procedure.

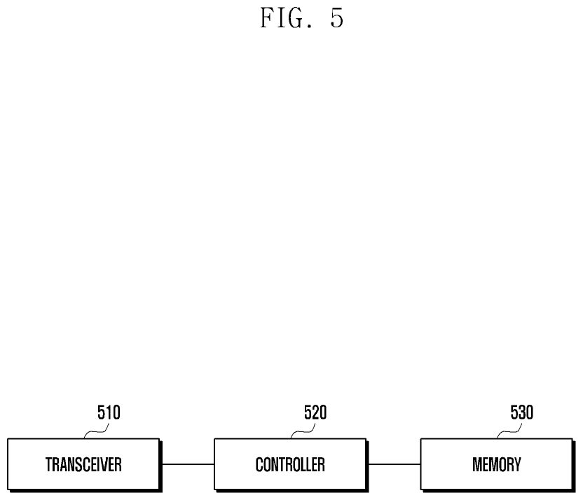

FIG. 5 illustrates a terminal according to an embodiment.

Referring to FIG. 5, the terminal includes a transceiver 510, a controller 520, and a memory 530. The controller 520 may refer to circuitry, an ASIC, or at least one processor. The transceiver 510, the controller 520, and the memory 530 are configured to perform the operations of the terminal illustrated in the FIGS. 1 to 4, or described above.

Although the transceiver 510, the controller 520, and the memory 530 are shown as separate entities, they may be realized as a single entity like a single chip. The transceiver 510, the controller 520, and the memory 530 may be electrically connected to or coupled with each other.

The transceiver 510 may transmit and receive signals to and from other entities, i.e., a BS.

The controller 520 may control the terminal to perform functions according to at least one of the embodiments described above. For example, the controller 520 controls the transceiver 510 to perform a transmission for an SDT procedure and perform monitoring a paging for MBS multicast reception. The controller 520 controls the transceiver 510 and/or the memory 530 to perform an operation of monitoring paging or an operation of the SDT procedure in accordance with various embodiments of the disclosure.

In an embodiment of the disclosure, the operations of the terminal may be implemented using the memory 530 storing corresponding program codes. Specifically, the terminal may be equipped with the memory 530 to store program codes implementing desired operations. To perform the desired operations, the controller 520 may read and execute the program codes stored in the memory 530 by using at least one processor or a central processing unit (CPU).

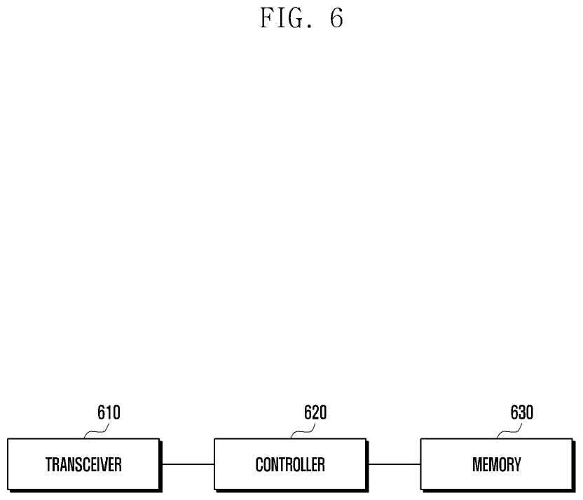

FIG. 6 illustrates a BS according to an embodiment.

Referring to FIG. 6, the BS includes a transceiver 610, a controller 620, and a memory 630. The controller 620 may refer to circuitry, an ASIC, or at least one processor. The transceiver 610, the controller 620, and the memory 630 are configured to perform the operations of the terminal illustrated in the FIGS. 1 to 4, or described above.

Although the transceiver 610, the controller 620, and the memory 630 are shown as separate entities, they may be realized as a single entity like a single chip. The transceiver 610, the controller 620, and the memory 630 may be electrically connected to or coupled with each other.

The transceiver 610 may transmit and receive signals to and from other network entities, i.e., a terminal.

The controller 620 may control the BS to perform functions according to at least one of the embodiments described above. For example, the controller 620 controls the transceiver 610 to transmit configuration information associated with an MRB for multicast session or a confirmation to the terminal as a response to a transmission of an SDT from the terminal.

In an embodiment, the operations of the BS may be implemented using the memory 630 storing corresponding program codes. Specifically, the BS may be equipped with the memory 630 to store program codes implementing desired operations according to various embodiments of the disclosure. To perform the desired operations, the controller 620 may read and execute the program codes stored in the memory 630 by using at least one processor or a CPU.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station (BS), a radio resource control (RRC) release message including information indicating a suspend configuration for an RRC inactive state;
identifying whether a small data transmission (SDT) procedure is ongoing in the RRC inactive state, in case that there is a configuration by an upper layer for a multicast and broadcast service (MBS) multicast reception; and
monitoring a paging channel for paging using a temporary mobile group identity (TMGI) associated with an MBS session, based on the SDT procedure being not ongoing,
wherein the MBS session is associated with a bearer for the MBS multicast reception.

2. The method of claim 1, further comprising:
not monitoring the paging channel for paging using the TMGI associated with the MBS session, based on the SDT procedure being ongoing.

3. The method of claim 1, wherein monitoring the paging channel for paging using the TMGI comprises:
receiving, from the BS, a paging message; and
identifying whether the paging message includes information on the TMGI.

4. The method of claim 3, wherein, in case that the paging message includes the information on the TMGI and a user equipment (UE) identifier (ID) included in the paging message matches an ID allocated for the terminal, an RRC connection resumption procedure is initiated.

5. The method of claim 1, wherein the SDT procedure is identified as ongoing based on an SDT error detection timer running.

6. The method of claim 1, wherein configuration information on the bearer associated with the MBS session is received from the BS via dedicated RRC signaling, while the terminal is in an RRC connected state.

7. The method of claim 1, wherein the RRC release message further includes information on an SDT configuration.

8. A terminal in a wireless communication system, the terminal comprising:
a transceiver; and
a controller configured to:
control the transceiver to receive, from a base station (BS), a radio resource control (RRC) release message including information indicating a suspend configuration for an RRC inactive state,
identify whether a small data transmission (SDT) procedure is ongoing in the RRC inactive state, in case that there is a configuration by an upper layer for a multicast and broadcast service (MBS) multicast reception, and
monitor a paging channel for paging using a temporary mobile group identity (TMGI) associated with an MBS session, based on the SDT procedure being not ongoing,
wherein the MBS session is associated with a bearer for the MBS multicast reception.

9. The terminal of claim 8, wherein the controller is further configured not to monitor the paging channel for paging using the TMGI associated with the MBS session, based on the SDT procedure being ongoing.

10. The terminal of claim 8, wherein the controller is further configured to monitor the paging channel for paging using the TMGI by:
receiving, from the BS, a paging message, and
identifying whether the paging message includes information on the TMGI.

11. The terminal of claim 10, wherein the controller is further configured to initiate an RRC connection resumption procedure, in case that the paging message includes the information on the TMGI and a user equipment (UE) identifier (ID) included in the paging message matches an ID allocated for the terminal.

12. The terminal of claim 8, wherein the SDT procedure is identified as ongoing based on an SDT error detection timer running.

13. The terminal of claim 8, wherein configuration information on the bearer associated with the MBS session is received from the BS via dedicated RRC signaling, while the terminal is in an RRC connected state.

14. The terminal of claim 8, wherein the RRC release message further includes information on an SDT configuration.
